(19) United States
(12) Patent Application Publication
(10) Pub. No.: US 2006/0102718 A1
(43) Pub. Date: May 18, 2006

(54) Filing security system and article security system

(76) Inventors: Yoshiyuki Kajino, Tokyo (JP); Masahiro Ando, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/259,071

(22) Filed: Oct. 27, 2005

(30) Foreign Application Priority Data
Oct. 29, 2004 (JP) 2004-316646

(51) Int. Cl. G06Q 30/00

(52) U.S. Cl. 235/385

(57) ABSTRACT

The present invention provides a filing security system which allows files, such as important documents, and the like, to be managed with a simple and low-cost configuration, and a high security. The filing security system of the present invention comprises a document folder 30 for accommodating a file; a folder cabinet 50 for accommodating document folders 30; an RFID tag 3 which is attached to an individual document folder 30, on which specific medium identification information is recorded, and which is capable of recording information thereon and reading information therefrom; an antenna 58 for detecting the RFID tag 3 attached to the individual document folder 30 that is provided for said folder cabinet 50; a shelf sensor 55 for detecting coming-in and going-out of the individual document folder 30 into/from said folder cabinet 50 that is provided for the shelf of the folder cabinet 50; an antenna controller 21 which switches over the detection operation of the antenna 58 by the time-sharing switchover method, and on the basis of a signal of the shelf sensor 55 that indicates said document folder 30 having been taken out from the folder cabinet 50, fixes the detection operation of the antenna 58 on the accommodation area for said document folder 30 to bring it into the monitored state; and management means for carrying out monitoring of coming-in and going-out of the document folder 30 and inventory management of the document folders 30 on the basis of the detection signals of the antenna 58 and the shelf sensor 55.

### BACKGROUND OF THE INVENTION

1. Field of the Invention

The present invention relates to a filing security system and an article security system, and more particularly to a filing security system and an article security system for managing important documents, important articles, and the like, with a high degree of security.

2. Description of the Related Art

For example, when important documents, such as various contract documents, real state related documents, and the like, are to be placed in a cabinet for storage and management, it is required to exactly grasp the management situation about which important document was taken out and returned by whom and at what date, and the like.

In the patent document 1, a financing document management apparatus is disclosed which is configured such that, when a particular folder in which the necessary documents for a specific matter are filed is to be accommodated into or taken out from a cabinet, the identification information on the ID card attached to the folder is read out, and the accommodation situation, and the like, of the individual folders are managed for displaying the management information on the screen, thus allowing efficient management of the necessary documents for each particular matter.

However, with this financing document management apparatus disclosed in the patent document 1, management of the accommodation situation, and the like, of the folders in which the necessary documents are filed can be carried out, but the operator who has taken out or returned a particular folder cannot be grasped, and for each of the plurality of cabinets, means for reading out the identification information on the ID card is required, which has presented problems of security, and the complexity of the apparatus configuration.

Patent Document 1

Patent Publication No. JP/P2000-38202A/2000

### SUMMARY OF THE INVENTION

The present invention has been made in consideration of the above problems, and the purposes of the present invention are to provide a filing security system and an article security system which allow files, such as important documents, and the like, and important articles to be managed with a simple and low-cost configuration, and a high security.

A first aspect of the filing security system of the present invention provides a filing security system, comprising: a document folder for accommodating a file; a folder cabinet for accommodating document folders; a non-contact type recording medium which is attached to an individual document folder, on which specific medium identification information is recorded, and which is capable of recording information thereon and reading information therefrom; non-contact type recording medium detection means for detecting the non-contact type recording medium attached to the individual document folder that is provided for said folder accommodation means; coming-in and going-out detection means for detecting coming-in and going-out of the individual document folder into/from said folder accommodation means that is provided for the folder accommodation means; and management means for controlling said non-contact type recording medium detection means, and said coming-in and going-out detection means, and on the basis of the detection signals of these, carrying out monitoring of coming-in and going-out of the document folder into/from the folder cabinet and inventory management of the document folders.

According to the present invention, the following effects are provided.

According to the present invention of claims 1 to 3, by attaching a non-contact type recording medium on which specific medium identification information is recorded, and which is capable of recording information thereon and reading information therefrom, to each individual document folder; mounting non-contact type recording medium detection means for detecting a non-contact type recording medium, and coming-in and going-out detection means for detecting coming-in and going-out of a document folder to the folder accommodation means; using the management means for controlling the non-contact type recording medium detection means, and the coming-in and going-out detection means, and on the detection signals of these, carrying out coming-in and going-out monitoring of the document folder into/from the folder cabinet, and inventory management of the document folders, a filing security system which can manage the files, such as the important documents, and the like, with a high security can be provided. In addition, by configuring the system to comprise a monitoring controller which switches over the detection operation of said non-contact type recording medium detection means by the time-sharing switchover method, a filing security system which has a simple and low-cost configuration, and can manage the files, such as the important documents, and the like, with a high security can be provided. Further, by configuring the system to additionally comprise room coming-in and going-out detection means for detecting an operator who opens/closes the door of the room, in relation to the personal identification information recorded on the personal identification medium carried by the operator, a filing security system which has a simple and low-cost configuration, and can manage the files, such as the important documents, and the like, with a high security including the management of the operator can be provided.

According to the invention of claim 4, by configuring the system to comprise a document folder for accommodating a file that is disposed in a room having a door; a folder cabinet comprising shelves for accommodating document folders; and an RFID tag which is attached to an individual document folder, on which specific medium identification information is recorded, and which is capable of recording information thereon and reading information therefrom; and further comprise management means for carrying out monitoring of coming-in and going-out of the document folder into/from the folder cabinet and inventory management of the document folders in relation to said personal identification information on the basis of the detection signals of the antenna and the shelf sensor; and output means which is capable of visually outputting management information by the management means, a filing security system which has a simple and low-cost configuration, and can manage the files, such as the important documents, and the like, with a high security including the management of the operator can be provided.

According to the present invention of claims 5 to 7, by attaching a non-contact type recording medium on which specific medium identification information is recorded, and which is capable of recording information thereon and reading information therefrom, to each individual article; mounting non-contact type recording medium detection means for detecting a non-contact type recording medium, and coming-in and going-out detection means for detecting coming-in and going-out of an article to the article accommodation means; using the management means for controlling the non-contact type recording medium detection means, and the coming-in and going-out detection means, and on the detection signals of these, carrying out coming-in and going-out monitoring of the article into/from the article accommodation means, and inventory management of the articles, an article security system which can manage the articles, and the like, with a high security can be provided. In addition, by configuring the system to comprise a monitoring controller which switches over the detection operation of said non-contact type recording medium detection means by the time-sharing switchover method, an article security system which has a simple and low-cost configuration, and can manage the articles, and the like, with a high security can be provided. Further, by configuring the system to additionally comprise room coming-in and going-out detection means for detecting an operator who opens/closes the door of the room, in relation to the personal identification information recorded on the personal identification medium carried by the operator, an article security system which has a simple and low-cost configuration, and can manage the articles, and the like, with a high security including the management of the operator can be provided.

According to the invention of claim 8, by configuring the system to comprise a storage shelf unit comprising shelves for accommodating articles that is disposed in a storage room having a door; and an RFID tag which is attached to an individual article, on which specific medium identification information is recorded, and which is capable of recording information thereon and reading information therefrom; and further comprise management means for carrying out monitoring of coming-in and going-out of the article into/from the storage shelf unit and inventory management of the articles in relation to said personal identification information on the basis of the detection signals of the antenna and the shelf sensor; and output means which is capable of visually outputting management information by the management means, an article security system which has a simple and low-cost configuration, and can manage the articles, and the like, with a high security including the management of the operator can be provided.

The present invention has achieved the purpose of managing files, such as important documents, and the like, with a simple and low-cost configuration, and a high security by providing a scheme comprising a document folder for accommodating a file; a folder cabinet for accommodating document folders; a non-contact type recording medium which is attached to an individual document folder, on which specific medium identification information is recorded, and which is capable of recording information thereon and reading information therefrom; non-contact type recording medium detection means for detecting the non-contact type recording medium attached to the individual document folder that is provided for said folder cabinet; coming-in and going-out detection means for detecting coming-in and going-out of the individual document folder into/from said folder cabinet that is provided for the folder cabinet; a monitoring controller which switches over the detection operation of said non-contact type recording medium detection means by the time-sharing switchover method, and on the basis of a signal of said coming-in and going-out detection means that indicates said document folder having been taken out from the folder cabinet, fixes the detection operation of said non-contact type recording medium detection means on the accommodation area for said document folder to bring it into the monitored state; and management means for controlling said non-contact type recording medium detection means, said monitoring controller, and said coming-in and going-out detection means, and on the basis of the detection signals of said non-contact type recording medium detection means and said coming-in and going-out detection means, carrying out monitoring of coming-in and going-out of the document folder into/from the folder cabinet, and inventory management of the document folders.

### BRIEF DESCRIPTION OF THE DRAWINGS

FIG. 1 is a schematic perspective side view illustrating the entire configuration of the filing security system of an embodiment of the present invention;

FIG. 2 is a schematic front view illustrating the configuration of the filing security system of the present embodiment;

FIG. 3 is a perspective side view illustrating a document folder and a folder cabinet in the filing security system of the present embodiment;

FIG. 4 is a perspective side view illustrating a shelf plate of the folder cabinet in the filing security system of the present embodiment;

FIG. 5 is a schematic plan view of an RFID tag in the present embodiment;

FIG. 6 is a block diagram of the filing security system in the present embodiment;

FIG. 7 is a drawing illustrating an example of output of management information in the filing security system in the present embodiment;

FIG. 8 is a drawing illustrating an example of output of management information in an abnormal state of the filing security system in the present embodiment;

FIG. 9 is a drawing illustrating an example of output of management information in combination with personal identification information in the filing security system in the present embodiment; and

FIG. 10 is a schematic perspective side view illustrating the entire configuration of an article security system as an application of the present invention.

### BEST MODE FOR CARRYING OUT THE INVENTION

Hereinbelow, the embodiment of the present invention will be described in detail with reference to the attached drawings.

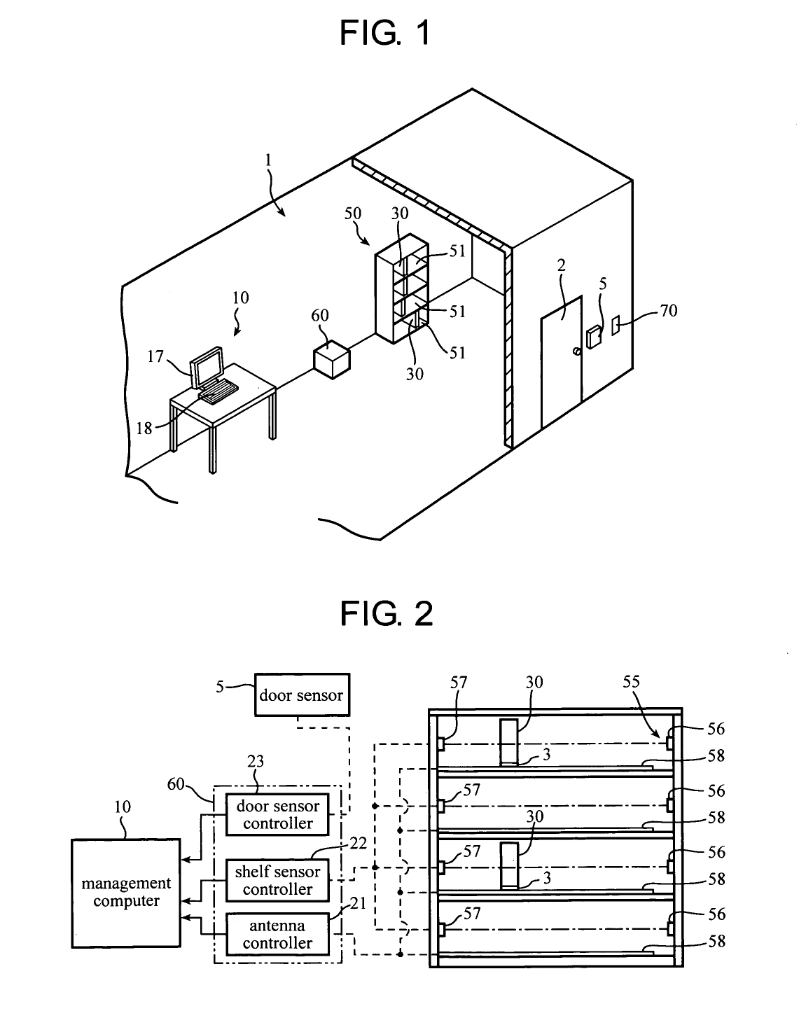

FIG. 1 and FIG. 2 show the entire configuration of the filing security system of the present embodiment, and as shown in FIG. 1, this filing security system is configured to comprise a folder cabinet 50 which is disposed in a specific room 1, such as an office, or the like, having a door 2, and which is equipped with, for example, four shelves 51 which can line and accommodate document folders 30 for containing a document, such as a paper, an envelope, or the like, (hereinafter, to be called “a file F”); a management computer 10 for carrying out management of this entire filing security system; a controller box 60 later described in detail; and a door sensor 5 which is installed on a wall in the vicinity of said door 2, and which detects the personal identification information recorded on an ID card 70 carried by an operator who opens and closes said door 2.

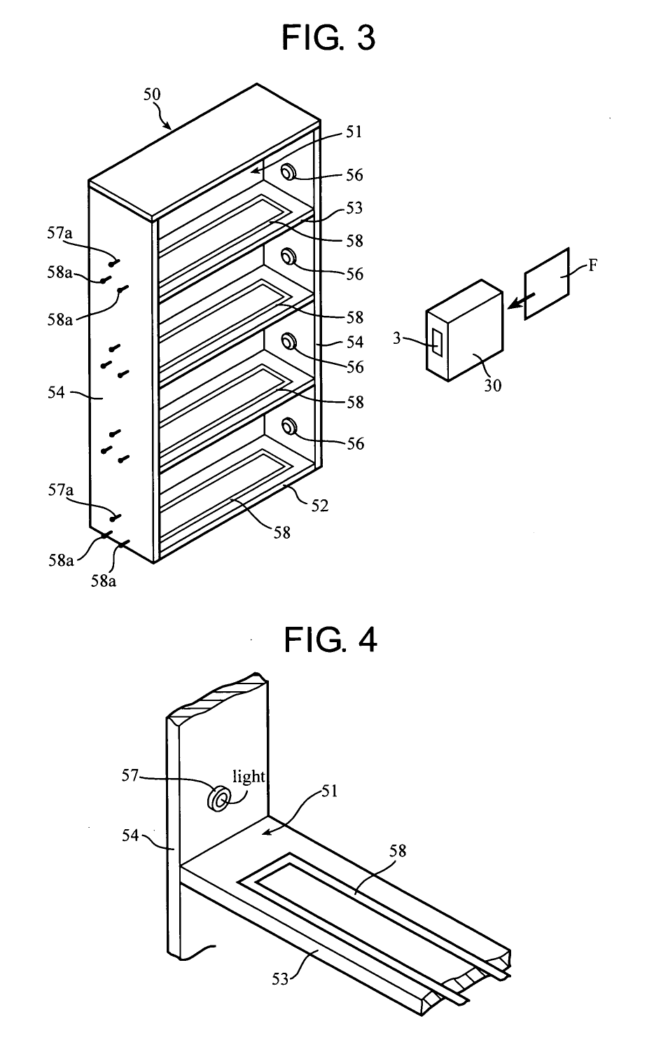

The folder cabinet 50 equipped with said document folders 30, and shelves 51 will be described in detail with reference also to FIG. 3 and FIG. 4. Said document folder 30 is formed in the shape of a box having an opening through which the file F can be inserted or removed, and to the bottom thereof, a well-known RFID (Radio Frequency Identification System) tag 3 is attached.

Said folder cabinet 50 comprises a bottom plate 52, three shelf plates 53, and a pair of side plates 54, being configured to have four shelves 51, and in each shelf 51, document folders 30 are lined and accommodated.

On the respective tops of said bottom plate 52, and said three shelf plates 53, an antenna 58 for detecting the RFID tag 3 attached to the individual document folders 30 accommodated in said folder cabinet 50, as shown in FIG. 4.

In addition, between the pair of side plates 54 constituting the four shelves 51 of said folder cabinet 50, a set of four shelf sensors 55 in total for optically detecting coming-in and going-out of the individual document folders 30 into/from said folder cabinet 50 are mounted.

As shown in FIG. 2, said respective shelf sensors 55 are constituted by combining a light emitting device 56 disposed on one side plate 54 that emits light, with a photo detector 57 disposed on the other side plate 54 in opposition thereto that receives light from the light emitting device 56, and on the basis of whether the light from the light emitting device 56 to the photo detector 57 has been cut off or not, detect coming-in and going-out of each particular document folder 30 into/from the shelf 51 of said folder cabinet 50. In FIG. 3, the number 57a indicates a lead wire from the photo detector 57, and the number 58a a lead wire from the antenna 58.

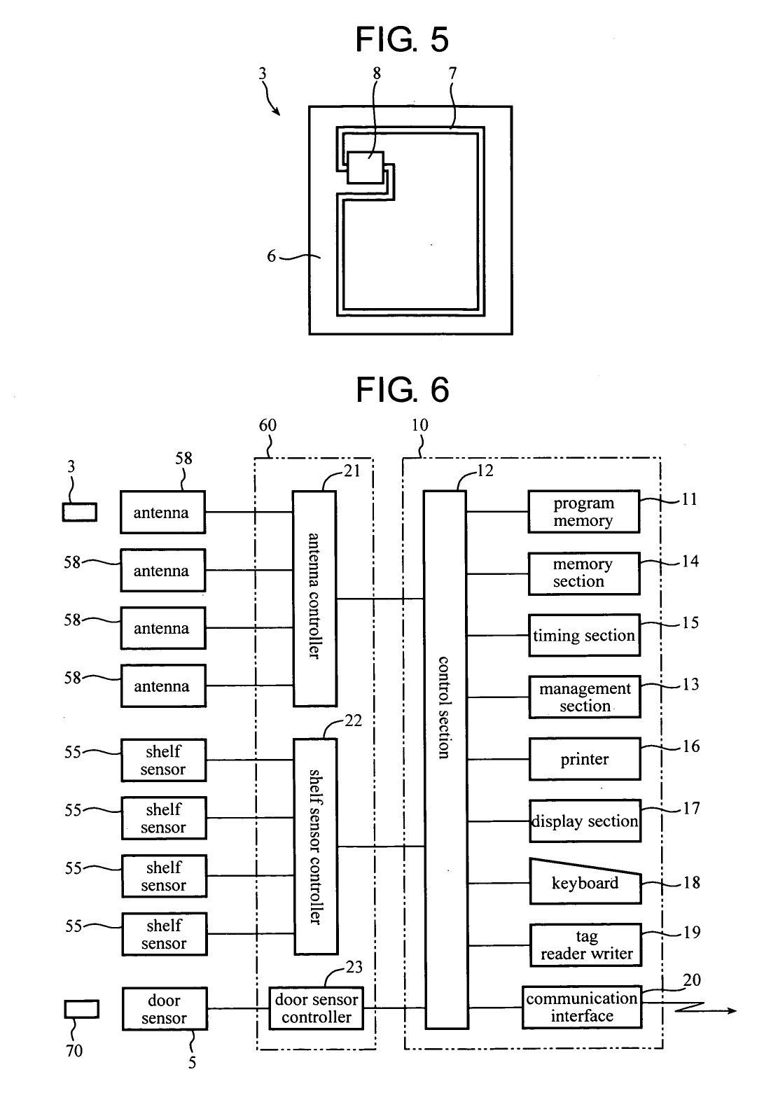

As shown in FIG. 5, said RFID tag 3 is constituted by accommodating a coil 7 which is film-like, being formed in the shape of a rectangle, for example, for carrying out transmission and reception of a signal by the electromagnetic induction method, and an IC chip 8 to which this coil 7 is connected, which is provided with a function for writably/readably recording a variety of pieces of information, and in which the specific identification information (the tag code) has been previously recorded, in a tag main body 6 made of a synthetic resin. And, this RFID tag 3 is attached to the bottom of said document folder 30.

Next, with reference to FIG. 6, the control system for the filing security system in the present embodiment will be described.

This filing security system comprises a program memory 11 which previously stores an operation program for operating the filing security system, being loaded in said management computer 10; a control section 12 which carries out control of the entire system on the basis of the operation program; management means 13 for carrying out coming-in and going-out management, and inventory management of document folders 30 and preparing management information; memory section 14 for storing various pieces of information, such as management information, and the like; a timing section 15 which provides date hour information; a printer 16 which print-outputs various pieces of information, such as management information, and the like; a display section 17 which displays various pieces of information, such as management information, and the like; a keyboard 18 for inputting various pieces of character information, and the like; a tag reader writer 19 which is capable of reading identification information from said RFID tag 3; and a communication interface 20 for carrying out information transfer to an external apparatus (for example, the computer system in the head office).

In addition, said control section 12 carries out operation control of an antenna controller 21 which controls said antennas 58 by the time-sharing switchover method (poling method), and a shelf sensor controller 22 which controls said shelf sensors 55. Further, said control section 12 carries out operation control of a door sensor controller 23 which controls said door sensor 5.

Said antenna controller 21, said shelf sensor controller 22, and said door sensor controller 23 are accommodated in said controller box 60.

As the method for communication between said antenna controller 21, said shelf sensor controller 22, or said door sensor controller 23, and said management computer 10, various communication methods, such as the cable method, the wireless method, the infrared-ray communication method, and the like, are available. In addition, the installation location of said management computer 10 is not limited to that as shown in FIG. 1, and may, of course, be that other than the room 1.

Said antenna controller 21 monitors the antennas 58 for the respective shelves 51 by the time-sharing switchover method which switches over the monitoring object antenna every 10 sec. In other words, the respective shelves, i.e., the first, second, third, and fourth shelves are monitored in sequence, the monitoring object antenna being switched over every 10 sec. Thereby, only one antenna controller 21 is required, which allows the equipment configuration to be simplified, and the equipment cost to be reduced, as compared to the case where four antenna controllers 21 in total are installed for the respective antennas 58.

Next, the operation of the filing security system of the present embodiment will be described.

Let's assume that, in the respective shelves 51 of said folder cabinet 50, some document folders 30, for example, are previously accommodated, and at this time, the identification information (such as “0001”, or the like) recorded on the RFID tag 3 attached to the respective document folders 30 is automatically detected by the respective antennas 58 provided for the shelves 51, and through the antenna controller 21, transmitted to the management computer 10 to be grasped and managed by the management section 13 (the filing security system is in the inventory management state).

In addition, said antenna controller 21 is carrying out operation control of the antennas 58 provided for the respective shelves 51 by the time-sharing switchover method.

Now, when a specific document folder 30 on a particular shelf 51 of the document folders 30 on said respective shelves 51 is taken out, said shelf sensor 55 provided for the shelf 51 issues a detection signal. The detection signal of the shelf sensor 55 is transmitted to said control section 12 through the shelf sensor controller 22, whereby said antenna controller 21 fixes the monitoring operation by the antenna 58 for the shelf 51 to which the shelf sensor 55 belongs, under the control of said control section 12.

Then, when said shelf sensor 55 issues a detection signal within a prescribed period of time (for example, 30 min, or the like), in other words, when the document folder 30 is returned to said shelf 51, the antenna 58 for the shelf 51 to which the shelf sensor 55 belongs recognizes the identification information on said RFID tag 3 attached to the document folder 30, and in the same manner as described above, the identification information is grasped and managed by said management section 13.

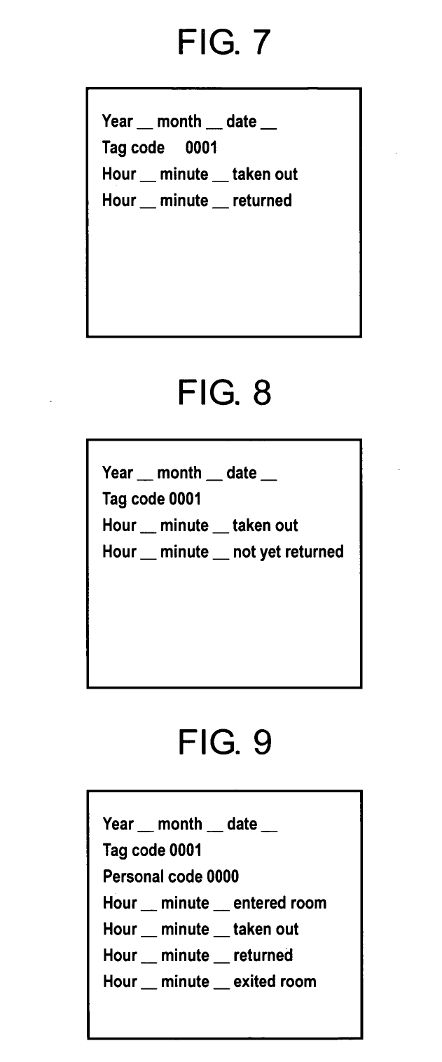

FIG. 7 gives an example of output of the management information by said management section 13 in such a case. In other words, said management section 13 manages a series of pieces of information from the moment when a document folder 30 is taken out in the above-mentioned inventory management state to the moment when it is returned, in relation to the timing information provided by said timing section 15; prepares management information comprising the information about the year, month, date, hour, and minute of the moment when the document folder 30 was taken out and returned; and stores the management information in said memory section 14. This management information is displayed on said display section 17, or print-outputted by said printer 16 as shown in FIG. 7, as required, for allowing it to be visually grasped.

On the other hand, when said shelf sensor 55 issues no detection signal within a prescribed period of time (for example, 30 min, or the like) after a document folder 30 being taken out, in other words, when the document folder 30 is not returned to said shelf 51, said management computer 10 can determine it as an abnormal state, and can raise a flag, give an alarm, or otherwise take a step.

FIG. 8 gives an example of output of the management information by said management section 13 in such an abnormal state.

Further, the operation of the filing security system that is combined with the ID card 70 and the door sensor 5 in the present embodiment will be described below.

The door sensor 5 installed on the wall in the vicinity of said door 2 detects the personal identification information recorded on the ID card 70 carried by the operator who opens said door 2, enters the room 1, takes out or return the document folder 30, and exits the room 1.

The personal identification information on the ID card 70 detected by the door sensor 5 is sent to the control section 12 through said door sensor controller 33, whereby said management section 13 manages a series of pieces of information from the moment when a document folder 30 is taken out in the above-mentioned inventory management state to the moment when it is returned, in relation to the timing information provided by said timing section 15; and prepares management information by combining the information about the year, month, date, hour, and minute of the moment when the document folder 30 was taken out and returned, with the information about entering and exiting the room 1 of said operator, and the year, month, date, hour, and minute of the entering and exiting; and stores the management information in said memory section 14. The management information in this case is displayed on said display section 17, or print-outputted by said printer 16 as shown in FIG. 9, as required, for allowing it to be visually grasped.

As a result of this, management of matters, such as which document folder 30 was taken out and returned by whom and at what date, and which document folder 30 was taken out by whom and at what date, but has not yet been returned, and the like, can be realized with a simple and low-cost configuration, and a high security.

The above-described scheme may be combined with the information about whether permission to enter said room 1 was given by the superior in an organization, such as a firm, or the like, in order to further enhance the security.

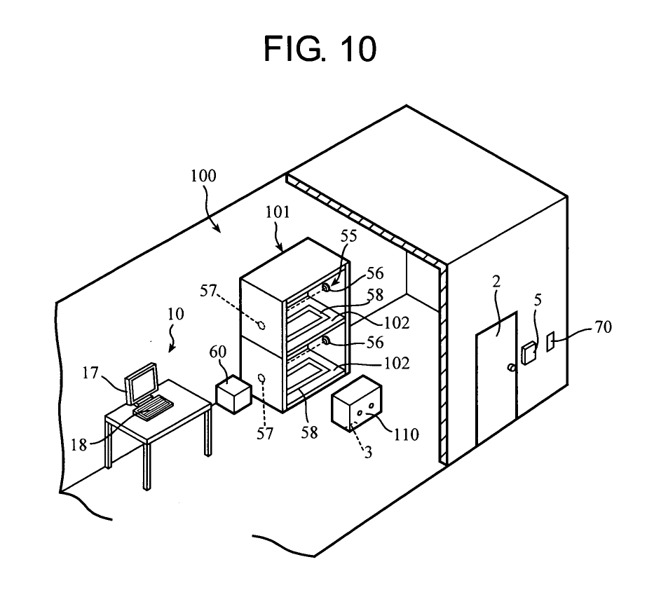

Next, with reference to FIG. 10, an article security system which is an application of the filing security system of the present embodiment will be described.

The article security system as shown in FIG. 10 is an application of the filing security system of the present embodiment for management of a plurality of measuring instruments 110 as management object articles in a storage room 100 at a plant, or the like.

In the article security system as shown in FIG. 10, the same elements as those of the filing security system as described above are shown, being provided with the same sign.

This article security system is configured by installing a door sensor 5 on a door 103 for entering a storage room 100 at a plant, or the like, as described above, for carrying out detection of an ID card 70 carried by an operator; installing a storage shelf unit 101 having two shelves 102, for example, for accommodating a measuring instrument 110 in the storage room 100; and further by installing a management computer 10 and a controller box 60 for managing the entire article security system which are the same as those mentioned above.

In addition, the article security system is configured by providing the respective shelves 103 of said storage shelf unit 101 with an antenna 58, and a shelf sensor 55 consisting of a light emitting device 56 and a photo detector 57 which have the same configuration as that in the above-mentioned folder cabinet 50, and using the same control system as that in said filing security system for carrying out control of said door sensor 5, said shelf sensors 55, and said antennas 58.

Also with the article security system thus configured, on the basis of the same operation as that of the above-described filing security system, the taking-out and returning said measuring instrument 110 from/to the storage shelf unit 101; the taking-out and returning said measuring instrument 110 from/to the storage shelf unit 101 in relation to the personal identification information recorded on the ID card 70 of the operator; further, the occurrence of an abnormal state, such as a loss, or the like, and the like, can be managed.

In other words, management of matters, such as which measuring instrument 110 was taken out and returned by whom and at what date, and which measuring instrument 110 was taken out by whom and at what date, but has not yet been returned, and the like, can be realized with a simple and low-cost configuration, and a high security.

This scheme may also be combined with the information about whether permission to enter said storage room 100 was given by the superior in an organization, such as a firm, or the like, in order to further enhance the security.

The present invention is not only applicable to management of the above-mentioned file F, the measuring instrument 110, and the like, but also widely applicable to various managed articles, such as shipment products, and the like, in a warehouse, or the like that are required to be handled with security.

What is claimed is:

1. A filing security system, comprising:
a document folder for accommodating a file;
a folder cabinet for accommodating document folders;
a non-contact type recording medium which is attached to an individual document folder, on which specific medium identification information is recorded, and which is capable of recording information thereon and reading information therefrom;
non-contact type recording medium detection means for detecting the non-contact type recording medium attached to the individual document folder that is provided for said folder accommodation means;
coming-in and going-out detection means for detecting coming-in and going-out of the individual document folder into/from said folder accommodation means that is provided for the folder accommodation means; and
management means for controlling said non-contact type recording medium detection means, and said coming-in and going-out detection means, and on the basis of the detection signals of these, carrying out monitoring of coming-in and going-out of the document folder into/from the folder cabinet and inventory management of the document folders.

2. A filing security system, comprising:
a document folder for accommodating a file;
a folder cabinet for accommodating document folders;
a non-contact type recording medium which is attached to an individual document folder, on which specific medium identification information is recorded, and which is capable of recording information thereon and reading information therefrom;
non-contact type recording medium detection means for detecting the non-contact type recording medium attached to the individual document folder that is provided for said folder accommodation means;
coming-in and going-out detection means for detecting coming-in and going-out of the individual document folder into/from said folder cabinet that is provided for the folder cabinet;
a monitoring controller which switches over the detection operation of said non-contact type recording medium detection means by the time-sharing switchover method, and on the basis of a signal of said coming-in and going-out detection means that indicates said document folder having been taken out from the folder cabinet, fixes the detection operation of said non-contact type recording medium detection means on the accommodation area for said document folder to bring it into the monitored state; and
management means for controlling said non-contact type recording medium detection means, said monitoring controller, and said coming-in and going-out detection means, and on the basis of the detection signals of said non-contact type recording medium detection means and said coming-in and going-out detection means, carrying out monitoring of coming-in and going-out of the document folder into/from the folder cabinet and inventory management of the document folders.

3. A filing security system, comprising:
a document folder for accommodating a file that is disposed in a room having a door;
a folder cabinet for accommodating document folders;
a non-contact type recording medium which is attached to an individual document folder, on which specific medium identification information is recorded, and which is capable of recording information thereon and reading information therefrom;
non-contact type recording medium detection means for detecting the non-contact type recording medium attached to the individual document folder that is provided for said folder cabinet;
coming-in and going-out detection means for detecting coming-in and going-out of the individual document folder into/from said folder cabinet that is provided for the folder cabinet;
a monitoring controller which switches over the detection operation of said non-contact type recording medium detection means by the time-sharing switchover method, and on the basis of a signal of said coming-in and going-out detection means that indicates said document folder having been taken out from the folder cabinet, fixes the detection operation of said non-contact type recording medium detection means on the accommodation area for said document folder to bring it into the monitored state;
room coming-in and going-out detection means for detecting an operator who opens/closes the door of said room, in relation to the personal identification information recorded on a personal identification medium carried by the operator; and
management means for controlling said non-contact type recording medium detection means, said monitoring controller, said coming-in and going-out detection means, and said room coming-in and going-out detection means, and on the basis of the detection signals of said non-contact type recording medium detection means and said coming-in and going-out detection means, carrying out monitoring of coming-in and going-out of the document folder into/from the folder cabinet and inventory management of the document folders in relation to said personal identification information.

4. A filing security system, comprising:
a document folder for accommodating a file that is disposed in a room having a door;
a folder cabinet comprising shelves for accommodating document folders;
an RFID tag which is attached to an individual document folder, on which specific medium identification information is recorded, and which is capable of recording information thereon and reading information therefrom;
an antenna for detecting the RFID tag attached to the individual document folder that is provided for said folder cabinet;
an optical shelf sensor for detecting coming-in and going-out of the individual document folder into/from said folder cabinet that is provided for the shelf of the folder cabinet;
an antenna controller which switches over the detection operation of said antenna by the time-sharing switchover method, and on the basis of a signal of said shelf sensor that indicates said document folder having been taken out from the folder cabinet, fixes the detection operation of said antenna on the accommodation area for said document folder to bring it into the monitored state;
a door sensor for detecting an operator who opens/closes the door of said room, in relation to the personal identification information recorded on an ID card carried by the operator;
management means for controlling said antenna, said antenna controller, said shelf sensor, and said door sensor, and on the basis of the detection signals of said antenna and said shelf sensor, carrying out monitoring of coming-in and going-out of the document folder into/from the folder cabinet and inventory management of the document folders in relation to said personal identification information; and
output means which is capable of visually outputting management information by the management means.

5. An article security system, comprising:
an article accommodation means for accommodating managed articles;
a non-contact type recording medium which is attached to an individual managed article, on which specific medium identification information is recorded, and which is capable of recording information thereon and reading information therefrom;
non-contact type recording medium detection means for detecting the non-contact type recording medium attached to the individual managed article that is provided for said article accommodation means;
coming-in and going-out detection means for detecting coming-in and going-out of the individual managed article into/from said article accommodation means that is provided for the article accommodation means; and
management means for controlling said non-contact type recording medium detection means, and said coming-in and going-out detection means, and on the basis of the detection signals of these, carrying out monitoring of coming-in and going-out of the managed article into/from the article accommodation means and inventory management of the managed articles.

6. An article security system, comprising:
an article accommodation means for accommodating managed articles;
a non-contact type recording medium which is attached to an individual managed article, on which specific medium identification information is recorded, and which is capable of recording information thereon and reading information therefrom;
non-contact type recording medium detection means for detecting the non-contact type recording medium attached to the individual managed article that is provided for said article accommodation means;
coming-in and going-out detection means for detecting coming-in and going-out of the individual managed article into/from said article accommodation means that is provided for the article accommodation means;
a monitoring controller which switches over the detection operation of said non-contact type recording medium detection means by the time-sharing switchover method, and on the basis of a signal of said coming-in and going-out detection means that indicates said managed article having been taken out from the article accommodation means, fixes the detection operation of said non-contact type recording medium detection means on the accommodation area for said managed article to bring it into the monitored state; and
management means for controlling said non-contact type recording medium detection means, said monitoring controller, and said coming-in and going-out detection means, and on the basis of the detection signals of said non-contact type recording medium detection means and said coming-in and going-out detection means, carrying out monitoring of coming-in and going-out of the managed article into/from the article accommodation means and inventory management of the managed articles.

7. An article security system, comprising:
an article accommodation means for accommodating managed articles that is disposed in a room having a door;
a non-contact type recording medium which is attached to an individual managed article, on which specific medium identification information is recorded, and which is capable of recording information thereon and reading information therefrom;
non-contact type recording medium detection means for detecting the non-contact type recording medium attached to the individual managed article that is provided for said article accommodation means;
coming-in and going-out detection means for detecting coming-in and going-out of the individual managed article into/from said article accommodation means that is provided for the article accommodation means;
a monitoring controller which switches over the detection operation of said non-contact type recording medium detection means by the time-sharing switchover method, and on the basis of a signal of said coming-in and going-out detection means that indicates said managed article having been taken out from the article accommodation means, fixes the detection operation of said non-contact type recording medium detection means on the accommodation area for said managed article to bring it into the monitored state;
room coming-in and going-out detection means for detecting an operator who opens/closes the door of said room, in relation to the personal identification information recorded on a personal identification medium carried by the operator; and
management means for controlling said non-contact type recording medium detection means, said monitoring controller, said coming-in and going-out detection means, and said room coming-in and going-out detection means, and on the basis of the detection signals of said non-contact type recording medium detection means and said coming-in and going-out detection means, carrying out monitoring of coming-in and going-out of the managed article into/from the article accommodation means and inventory management of the managed articles in relation to said personal identification information.

8. An article security system, comprising:
a storage shelf unit comprising shelves for accommodating articles that is disposed in a storage room having a door;
an RFID tag which is attached to an individual article, on which specific medium identification information is recorded, and which is capable of recording information thereon and reading information therefrom;
an antenna for detecting the RFID tag attached to the individual article that is provided for said storage shelf unit;
an optical shelf sensor for detecting coming-in and going-out of the individual article into/from said storage shelf unit that is provided for the shelf of the storage shelf unit;
an antenna controller which switches over the detection operation of said antenna by the time-sharing switchover method, and on the basis of a signal of said shelf sensor that indicates said article having been taken out from the storage shelf, fixes the detection operation of said antenna on the accommodation area for said article to bring it into the monitored state;
a door sensor for detecting an operator who opens/closes the door of said storage room, in relation to the personal identification information recorded on an ID card carried by the operator;
management means for controlling said antenna, said antenna controller, said shelf sensor, and said door sensor, and on the basis of the detection signals of said antenna and said shelf sensor, carrying out monitoring of coming-in and going-out of the article into/from the storage shelf unit and inventory management of the articles in relation to said personal identification information; and
output means which is capable of visually outputting management information by the management means.
